(19) United States
(12) Patent Application Publication
(10) Pub. No.: US 2007/0277683 A1
(43) Pub. Date: Dec. 6, 2007

(54) Electrically driven mechanical servo press machine

(76) Inventor: Nobuyuki Kawabata, Chiba (JP)

Correspondence Address: YOUNG & THOMPSON, 745 SOUTH 23RD STREET, 2ND FLOOR, ARLINGTON, VA, 22202, US

(21) Appl. No.: 11/710,550

(22) Filed: Feb. 26, 2007

(30) Foreign Application Priority Data
Jun. 5, 2006 (JP) 155585/2006

(51) Int. Cl. B30B 1/00

(52) U.S. Cl. 100/226

(57) ABSTRACT

An electrically driven mechanical servo press machine including a brake and a clutch is arranged such that a motor shaft of a servomotor is connected to a drive shaft or a sleeve of the mechanical servo press machine on a clutch side. With this arrangement, safety in control can be improved.

### BACKGROUND OF THE INVENTION

1. Field of the Invention

The present invention relates to an electrically driven mechanical servo press machine whose safety in control is enhanced in a servo press machine having excellent operation characteristics.

2. Description of the Related Art

A press machine is a processing machine for carrying out drawing, punching, bending, and the like to a plate member and a sheet member. Since a conventional press machine realizes its function by a purely mechanical arrangement, it is called a mechanical press machine. An example of the mechanical press machine will be explained with reference to FIG. 4.

FIG. 4 is a sectional view showing a drive portion, wherein reference numeral 1 denotes a casing, 11 denotes a compressed air inlet formed to the casing 1 to actuate a piston which will be explained later, 21 denotes a first rotating shaft (drive shaft), 22 denotes a second rotating shaft (follower shaft), 211 denotes a flywheel attached to one end of the first rotating shaft 21, 212 denotes a yoke attached to the other end of the first rotating shaft 21, 31 denotes a first hub attached to the second rotating shaft 22, 32 denotes a second hub likewise, 41 denotes a first outer ring disposed to the outside of the first hub 31, 42 denotes a second outer ring disposed to the outside of the second hub 32, 51 denotes friction plates disposed to an intermediate portion between the first hub 31 and the first outer ring 41, 52 denotes friction plates disposed to an intermediate portion between the second hub 32 and the second outer ring 42, 61 denotes the piston inserted into the casing 1 and movable in an axial direction, 62 denotes a sleeve attached to the second rotating shaft 22 and moved in the axial direction by the piston 61 through a bearing, 63 denotes a shifter moved in the axial direction by the sleeve 62, 64 denotes a pin inserted passing through the second hub 32, 65 denotes a spring inserted into the first hub 31 for pressing and returning the shifter 63, and 221 denotes a pinion attached to an end of the second rotating shaft 22, and the pinion 221 is meshed with a main gear attached to a crank of a not shown press machine.

The friction plates 51, 52 constitute a multi-plate clutch composed of friction plates engaged with the first inner hub 31 or the second inner hub 32 through spline-like grooves and friction plates engaged with the first outer ring 41 or the second outer ring 42, wherein the former friction plates and the latter friction plates are disposed alternately. Since the casing 1 is filled with a lubricant, this clutch is a wet clutch.

The flywheel 211 is attached to the one end of the drive shaft 21, and the drive shaft 21 is rotated at all times by being driven by a not shown motor.

Although the first outer ring 41 is coupled with the yoke 212 and rotated integrally with the first rotating shaft 21, the second outer ring 42 is not rotated because it is attached to the casing 1. The first hub 32, the friction plates 51, and the first outer ring 41 constitute a clutch portion, and the second hub 32, the friction plates 52, and the second outer ring 42 constitute a brake portion.

In contrast, when compressed air enters from the compressed air inlet 11, since the piston 61 is pushed thereby in a right direction, the shifter 63 is moved to a right side, and, when the compressed air is exhausted, the shifter 63 is pushed to return in a left direction. When the shifter 63 is moved in the right direction, the friction plates 51 come into intimate contact with each other to thereby connect the clutch so that the first outer ring 41 is coupled with the first hub 31 and the second rotating shaft 22 is rotated together with the first rotating shaft 21.

When the shifter 63 is moved in the left direction, the friction plates 51 are separated from each other and the friction plates 52 come into intimate contact with each other so as to apply a brake. As a result, the second outer ring 42 is coupled with the second hub 32, and the second rotating shaft 22 is stopped because it is integrated with the casing 1 that does not rotate.

An operator carries out a press work by rotating and stopping the second rotating shaft 22 in synchronism with the flywheel 211 by supplying and discharging compressed air by actuating an electromagnetic valve by a switch. Although the mechanical press machine includes various types of presses such as a crank press, a knuckle press, a rink press, and the like, any of the presses moves a slide up and down by converting the rotating motion of a shaft into a reciprocating motion in an up/down direction. When this motion is explained using a crank press as an example, the motion of a slide is a so-called crank motion. When a stroke in the up/down direction is shown on a longitudinal axis and a time shown on a lateral axis, the motion draws a sine wave.

It should be noted that when a press machine is to be stopped in emergency, first, a clutch is disconnected, and a brake works at the same time. However, since brake torque is ordinarily designed to about 40-70% of clutch torque, it is difficult to absorb the entire kinetic energy of a flywheel instantly only by the brake.

Recently, a novel press machine called a servo press is put into market in place of the mechanical press machine described above. The servo press can carry out not only the same motions as those of the conventional mechanical press but also various motions which cannot be realized by the conventional press by coupling an ac servomotor with a drive shaft controlling it to an arbitrary speed.

The servo press can optionally control the speed of a slide so that the downward moving speed of the slide is reduced in press operation in which a large amount of torque is required and the slide is moved at a high speed when it is simply moved down or up. Further, the slide can be stopped only by stopping the servomotor itself. Since it is not necessary to idly rotate a motor at all times, it is contemplated that a clutch is not required.

Note that, to enhance control accuracy, the servo press machine is provided with a linear scale or an encoder for detecting an actual position of the slide.

As described above, in the servo press, since the motion of the slide is entirely controlled electrically, the press exhibits a desired performance when it operates normally. However, the servo press is disadvantageous in that when abnormal states such as breaking of wirings, disturbance, and the like occur, the press sometimes becomes uncontrollable, and the slide runs away without stopping at a set position or starts regardless that no regular start signal is issued. Even in the servo press, an ordinary brake cannot stop the slide within a short time of, for example, 100-250 ms unless the motor is stopped.

As one of countermeasures for avoiding the above risk, Japanese Unexamined Patent Application Publication No. 2002-283100 discloses to provide an overrun monitor in addition to an intrinsic controller to monitor an abnormal start signal, a speed out of a threshold value in inching operation, a braking distance out of a threshold value in emergency stop, and the like based on the position information from a linear scale for detecting a slide position.

Japanese Unexamined Patent Application Publication No. 2003-290997 discloses to increase braking force by providing a press drive servomotor with a strong electromagnetic brake. Further, Japanese Unexamined Patent Application Publication No. 2005-199314 discloses an overrun monitor so that a servo press is stopped by a mechanical brake when it is determined that a press speed exceeds a set value by a pulse coder for detecting the press speed.

Since these countermeasures basically depend on an electric system, a problem of reliability arises to the additionally provided monitor in addition to that a control system becomes more complex and an equipment cost increases, and there is a possibility that entire safety may not be improved so much.

Accordingly, an object of the present invention is to realize a servo press machine which improves safety of a control system and can be used with security.

### SUMMARY OF THE INVENTION

The present invention relates to an electrically driven mechanical servo press machine which has a brake and a clutch and is characterized in that a motor shaft of a servomotor is connected to a drive shaft or a sleeve of the mechanical servo press machine on a clutch side. In the electrically driven mechanical servo press machine, it is preferable that the servomotor be connected to the drive shaft or the sleeve through a belt mechanism.

The present invention can achieve an excellent advantage in that safety of the servo press machine can be improved and thus the reliability thereof can be enhanced.

### BRIEF DESCRIPTION OF THE DRAWINGS

FIG. 1 is a sectional view showing a drive portion of an electrically driven mechanical servo press machine of an example of the present invention;

FIG. 2 is a conceptual view showing a drive portion of an electrically driven mechanical servo press machine of a modification of the present invention;

FIG. 3 is a conceptual view showing a drive portion of an electrically driven mechanical servo press machine of a modification of the present invention likewise; and

FIG. 4 is a sectional view showing a drive portion of a mechanical press machine of a conventional example.

### DESCRIPTION OF THE PREFERRED EMBODIMENTS

According to the present invention, there can be realized a servo press machine with high safety in which not only any arbitrary slide motion suitable for the processing conditions of a work can be realized by using a servomotor but also the press machine can be stopped, when an abnormal state occurs, by shutting off power at once and actuating a brake by providing the press machine with a clutch and the brake similar to those of a conventional mechanical press machine regardless that it is driven by a servomotor.

### EXAMPLE

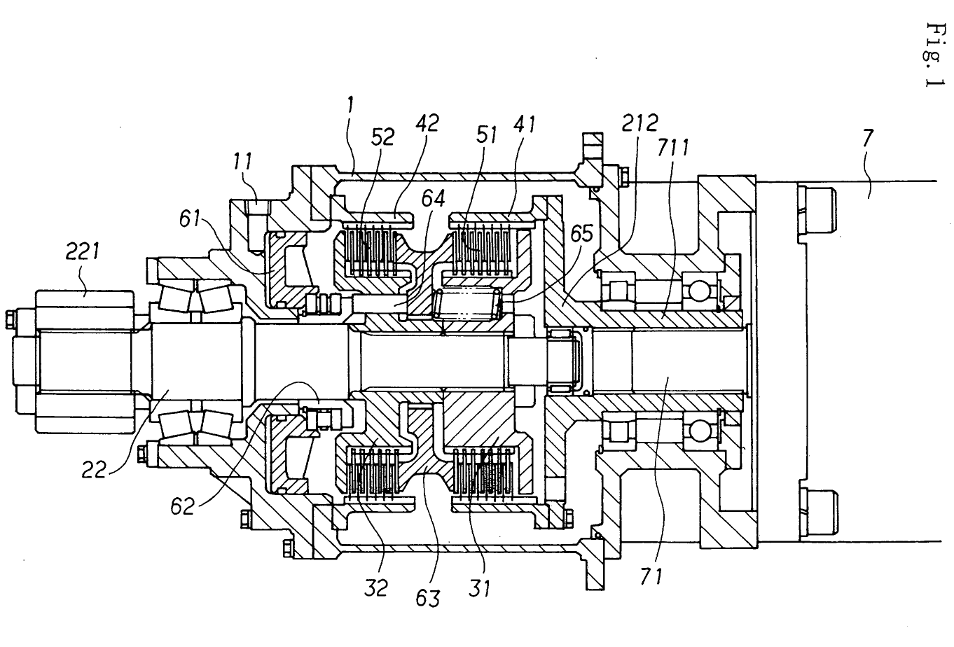

An example of the present invention will be explained referring to the drawings. FIG. 1 is a sectional view showing a drive portion of an electrically driven mechanical servo press machine of the example, wherein reference numeral 7 denotes a servomotor, 71 denotes a motor shaft, and 711 denotes a sleeve attached to the motor shaft 71 by a spline and the like, in addition to the components used above in FIG. 4. A yoke 212 to be connected to a first outer ring 41 is formed integrally with the sleeve 711.

The press machine includes a brake and a clutch likewise the conventional mechanical press machine shown in FIG. 4 and has the servomotor 7 directly attached thereto in place of the flywheel 211 in the conventional mechanical press machine shown in FIG. 4.

Not shown 2 encoders are attached to each of a crank shaft of the press machine and a motor shaft of the servomotor 7, and the position of a slide and the motion of the servomotor are monitored by these encoders. In a normal operating state in which no abnormal function are detected as a result of comparison of the position of the slide with the motion of the servomotor, since compressed air acts on a piston 61 and a shifter 63 overcomes a spring 65 and pushed in a right direction in FIG. 1, friction plates 51 are pressed and friction plates 52 are released. That is, the clutch is connected, and the brake does not work.

When any abnormal function is detected, since compressed air is discharged and the piston 61 is pushed in a left direction by the spring 65, the clutch is disconnected and the brake works. Although this operation is all the same as that of the conventional mechanical press machine, since the clutch is disconnected, the press machine can be easily stopped even by an ordinary brake capacity.

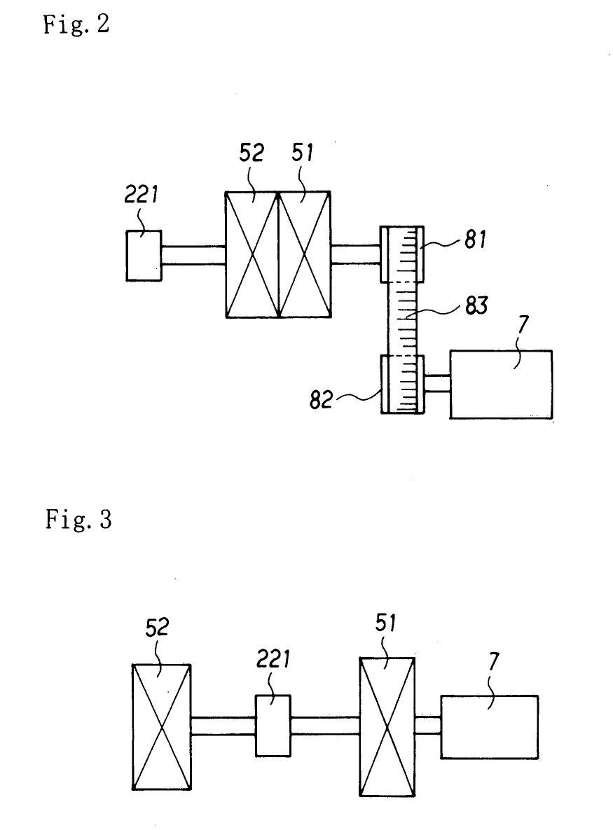

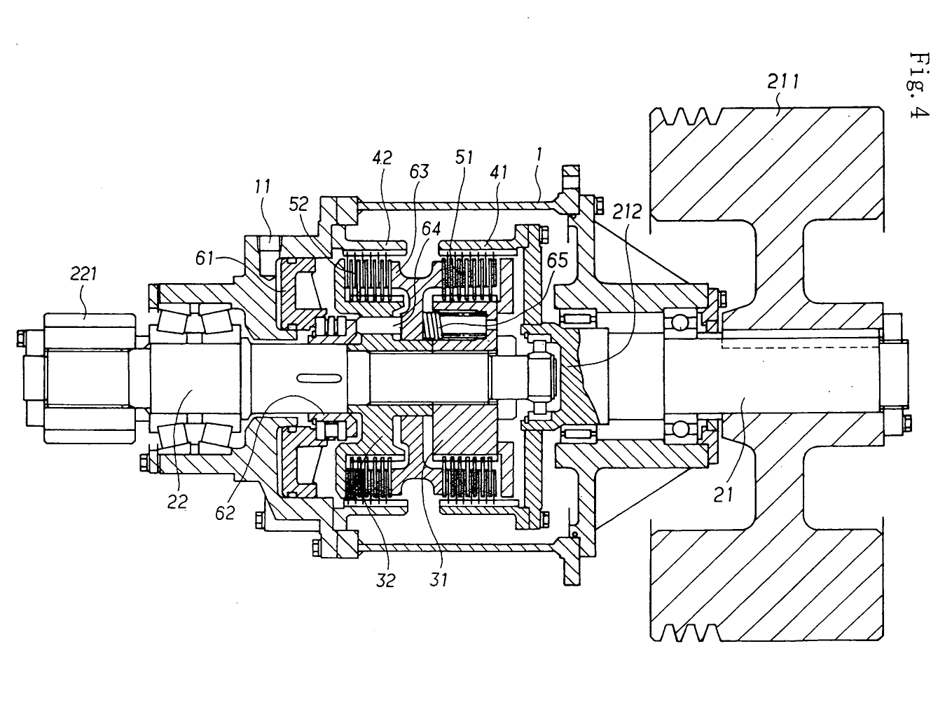

The press machine shown in FIG. 1 is provided with a clutch 51 and a brake 52 called a “combination type” and disposed side by side and the servomotor is directly coupled with an input shaft. However, as shown in, for example, FIG. 2, when power is transmitted by a belt mechanism composed of pulleys 81 and 82 and a timing belt 83, maintenance and the like of the servomotor can be easily carried out.

Further, in a large press machine and the like, although a clutch 51 and a brake 52 are disposed separately on the opposite sides across a pinion 221 as a separate type, the present invention can be applied to both types.

Although it is needless to say that the electrically driven mechanical servo press machine of the present invention may be manufactured newly, it can be easily realized by reforming an existing mechanical press machine as well.

What is claimed is:

1. An electrically driven mechanical servo press machine comprising a brake and a clutch, wherein a motor shaft of a servomotor is connected to a drive shaft or a sleeve of the mechanical servo press machine on a clutch side.

2. An electrically driven mechanical servo press machine according to claim 1, wherein the servomotor is connected to the drive shaft or the sleeve through a belt mechanism.
